(19) United States
(12) Patent Application Publication
(10) Pub. No.: US 2008/0109375 A1
(43) Pub. Date: May 8, 2008

(54) POSITION-ENHANCED WIRELESS TRANSACTION SECURITY

(76) Inventors: Christopher P. Ricci, Dayton, OH (US); Roderick W. MacLeod, Perthshire (GB)

Correspondence Address: JAMES M. STOVER;TERADATA CORPORATION, 2835 MIAMI VILLAGE DRIVE, MIAMISBURG, OH, 45342, US

(21) Appl. No.: 11/557,702

(22) Filed: Nov. 8, 2006

(51) Int. Cl. G06Q 30/00; H04L 9/32; G01S 5/00

(52) U.S. Cl. 705/76; 701/213; 701/207

(57) ABSTRACT

Methods and apparatus for enhancing the security of wireless transactions through the use of position information are provided. In particular, methods and apparatus are provided for wirelessly receiving information relating to a position of a wireless electronic device by a self-service terminal, and taking action on some or all of the steps of a wirelessly received transaction depending on the position information.

### BACKGROUND

Wireless electronic devices have been proposed for use as dislocated interfaces for wirelessly executing transactions at self-service terminals (SSTs). The term “dislocated interface” refers to the provision of a user interface on a wireless electronic device to wirelessly prepare and/or enter a transaction that is subsequently executed by a SST. This typically allows the user to avoid having to touch the SST user interface for execution of some or all of a transaction.

As used herein, a SST is defined as any electronic or electromechanical device that allows a user to conduct a transaction, or access information, in an unassisted manner and/or in an unattended environment. While a particular SST installation may provide for human assistance for, and/or supervision of users of the SST, SSTs are typically designed so that such assistance and/or supervision are not essential.

Typical SSTs include self-checkout systems, self-service kiosks, vending machines, automated teller machines (ATMs), and the like.

A self-checkout system is, for example, designed to allow a user to scan, bag and pay for retail purchases without cashier assistance at retail outlets. One example of a self-checkout system is a FASTLANE (trademark) system from NCR Corporation.

Self-service kiosks include (i) postal service kiosks for allowing a user to weigh letters and parcels, and purchase appropriate postage, (ii) non-cash kiosks that allow a user to access information such as viewing points remaining on a reward card, (iii) check-in kiosks such as those that allow users to check-in at airline terminals and hotels, and (iv) kiosks that accept payment for services such as web browsing kiosks and kiosks for purchasing goods (etc), and the like. An example of a self-service kiosk is an EASYPOINT (trademark) kiosk from NCR Corporation.

Vending machines include devices that dispense, for example, candy bars, drinks, cigarettes, toiletries, and the like.

ATMs include devices that, among other things, provide for depositing and/or dispensing of cash, obtaining account balance information, transferring funds, and the like. An example of an ATM is a PERSONAS (trademark) M Series ATM from NCR Corporation.

A wireless electronic device is typically a handheld or portable device such as a cellular telephone, a personal digital assistant (PDA), a notebook computer, or a personal entertainment device including a MP3 player, and the like. However, a wireless electronic device may also be an in-car entertainment and/or navigation system, or the like.

One problem associated with the use of a wireless electronic device as a dislocated interface for executing a transaction at a SST is that wireless communications can have a relatively wide transmission area, spanning tens or hundreds of meters or more from a source. As a result, if there are multiple SSTs situated relatively close to one another, then a first user may believe he or she is entering into a transaction with one SST only to have another SST execute some or all of it. This is particularly problematic when, as a part of, or in fulfillment of a transaction a SST dispenses valuable media such as, for example, cash. Absent secure means to ensure that such a dispense operation is made to an authorized user, a first user may believe it has wirelessly entered into a transaction involving the dispensing of valuable media with a first SST only to have the valuable media dispensed by a second SST. Alternately, a first user may properly enter into a wireless transaction with a desired SST only to have an item of value dispensed when a second user is at the SST. In either case, a second, unauthorized user may inappropriately receive valuable media intended for a first, authorized user.

### SUMMARY

In general, methods and apparatus for enhancing the security of wireless transactions through the use of position information are provided. A wireless transaction is defined as a transaction in which some or all of the information relating to a transaction, including initiation and/or fulfillment information, is communicated wirelessly between a wireless electronic device and a SST. Technologies for wireless communication between the wireless electronic device and the SST may include infrared (IR) transmission, radio frequency (RF) technologies including those described in the IEEE 802.x family of standards such as Wi-Fi, WiMAX, and Bluetooth (trademark), and cellular network technologies such as AMPS, GSM, TDMA, CDMA, and third-generation (3G) services, among others.

As used herein, position information is defined as information relating to a location such as absolute or relative latitude, longitude, altitude, time, and the like, obtained through the use of one or more positioning systems. Relevant positioning systems include satellite navigation systems such as Global Positioning System (GPS), Global Navigation Satellite System (GNSS), Galileo, Globalnaya Navigatsionnaya Sputnikovaya Sistema (GLONASS), European Geostationary Navigation Overlay System (EGNOS), the Beidou navigation system, and the like.

According to a first aspect, there is provided a method of operating a self-service terminal to secure a wireless transaction using position information, the method comprising: wirelessly receiving information relating to a transaction from a wireless electronic device;

wirelessly receiving information indicative of a first position of the wireless electronic device; determining if the first position information meets one or more predetermined criteria; and taking action on the transaction information in the event that the first position information meets the one or more predetermined criteria.

The method may further include taking action on the transaction information by dispensing at least one physical item to fulfill the transaction.

Additionally, the method may further comprise retrieving information indicative of a position of the self-service terminal, and determining if the first position information meets one or more predetermined criteria by, among other things, comparing the first position information with the information indicative of the position of the self-service terminal to ascertain if the wireless electronic device is within a predetermined distance of the self-service terminal.

Likewise, the method may further comprise the transaction information and the first position information being received as part of a spatial transaction block, and parsing the spatial transaction block to identify the respective transaction and first position information portions.

Further, the method may comprise the first position information being obtained through use of a satellite navigation system, such as GPS, associated with the wireless electronic device.

Moreover, the method may further comprise wirelessly receiving information indicative of a second position of the wireless electronic device; determining if the second position information meets the one or more predetermined criteria; and taking action on the transaction information in the event that the first and second position information meet the one or more predetermined criteria. In such case, at least one of the one or more predetermined criteria may comprise a difference between a first and a second position of the wireless electronic device as determined through use of the first and second position information being less than or equal to a predetermined value.

Where second position information is received, the method may further comprise wirelessly receiving a first time associated with the first position information; wirelessly receiving a second time associated with the second position information; determining if the first and second times meet the one or more predetermined criteria; and taking action on the transaction information in the event that the first and second position information and the first and second times meet the one or more predetermined criteria.

Similarly, where time information is received, the method may further comprise calculating a rate of change of position of the wireless electronic device using the first and second position information and the first and second times, and having at least one of the one or more predetermined criteria require the rate of change of position of the wireless electronic device be less than or equal to a predetermined value.

In addition, the method may further comprise determining a type of transaction represented by the transaction information, and varying at least one of the one or more predetermined criteria as a function of the determined transaction type. Likewise, the method may include wirelessly receiving at least one of the one or more predetermined criteria from the wireless electronic device.

According to a second aspect, a method of using a wireless electronic device as a secure interface for execution of a wireless transaction by a self-service terminal is provided, the method comprising: receiving into the wireless electronic device information relating to a transaction; acquiring information indicative of a first position of the wireless electronic device; appending the first position information to the transaction information to create a spatial transaction block; and wirelessly transmitting the spatial transaction block to the self-service terminal.

The method may further comprise establishing a wireless communication link between the wireless electronic device and the self-service terminal; and wirelessly transmitting the spatial transaction block to the self-service terminal using the established wireless communication link.

According to a third aspect, a self-service terminal is provided, the self-service terminal comprising: a communication module adapted to wirelessly receive information relating to a transaction from a wireless electronic device, and to wirelessly receive information indicative of a first position of the wireless electronic device from the wireless electronic device; and a controller adapted to determine if the first position information meets one or more predetermined criteria, and take action on the received transaction information in the event that the first position information meets the one or more predetermined criteria.

The communication module of the self-service terminal may be further adapted to wirelessly receive information indicative of a second position of the wireless electronic device, and the controller may be further adapted to determine if the second position information meets the one or more predetermined criteria and take action on the transaction information in the event that the first and second position information meet the one or more predetermined criteria.

Where the communication module is adapted to wirelessly receive information indicative of a second position information of the wireless electronic device the self-service terminal may further comprise a clock adapted to determine a first time to be associated with the first position information and a second time to be associated with the second position information, and the controller may be further adapted to take action on the transaction information in the event that the first and second position information and the first and second times meet the one or more predetermined criteria.

In addition, the self-service terminal may further comprise a positioning system module, such as a GPS module, adapted to provide information indicative of a position of the self-service terminal, and the controller may be further adapted to take action on the transaction information in the event that the first position information and the provided self-service terminal position information meet the one or more predetermined criteria.

According to a fourth aspect, a wireless electronic device is provided, the wireless electronic device comprising: a data entry module adapted to allow entry of information relating to a transaction for execution by a self-service terminal; a positioning system module, such as a GPS module, adapted to acquire information indicative of a first position of the wireless electronic device; a controller adapted to append the first position information to the transaction information to create a spatial transaction block; and a communication module adapted to establish a wireless communication link with the self-service terminal, and wirelessly transmit the spatial transaction block to the self-service terminal using the established wireless communication link.

The positioning system module of the wireless electronic device may be further adapted to acquire information indicative of a second position of the wireless electronic device, and the communication module may be further adapted to wirelessly transmit the second position information to the self-service terminal using the established communication link.

These and other aspects of the invention will be apparent from the following description and drawings, which are given by way of example, and from the appended claims.

### BRIEF DESCRIPTION OF THE DRAWINGS

FIG. 1 illustrates a cross-sectional view of a SST in the form of an ATM according to one embodiment of the present invention.

FIG. 2 illustrates a component (a controller module) of the ATM of FIG. 1.

FIG. 3 illustrates a cross-sectional view of a wireless electronic device in the form of a PDA for use with the ATM of FIG. 1.

FIG. 4A illustrates a component (a controller module) of the PDA of FIG. 3.

FIG. 4B illustrates sample input screens of an ATM Transaction Routine for execution on a wireless electronic device in the form of the PDA of FIG. 3.

FIG. 5 illustrates a user holding the PDA of FIG. 3, the user being shown in dashed line in a first position at a first time relative to the ATM of FIG. 1, and in solid line in a second position at a second time relative to the ATM of FIG. 1.

FIG. 6A is a flow chart illustrating steps performed by the ATM of FIG. 1 and the PDA of FIG. 3 to secure a wireless transaction using position information.

FIG. 6B is a flow chart illustrating steps performed by the ATM of FIG. 1 and the PDA of FIG. 3 to secure a piecewise wireless transaction using position information.

FIG. 7 is a flow chart illustrating the steps performed by the ATM of FIG. 1 to secure a wireless transaction using first position information of the PDA of FIG. 3.

FIG. 8 is a flow chart illustrating steps performed by the ATM of FIG. 1 to secure a wireless transaction using first and second position information of the PDA of FIG. 3.

FIG. 9A illustrates a user holding the PDA of FIG. 3 in a first position relative to a first ATM.

FIG. 9B illustrates the user of FIG. 9A holding the PDA of FIG. 3 in a second position relative to a second ATM.

### DETAILED DESCRIPTION

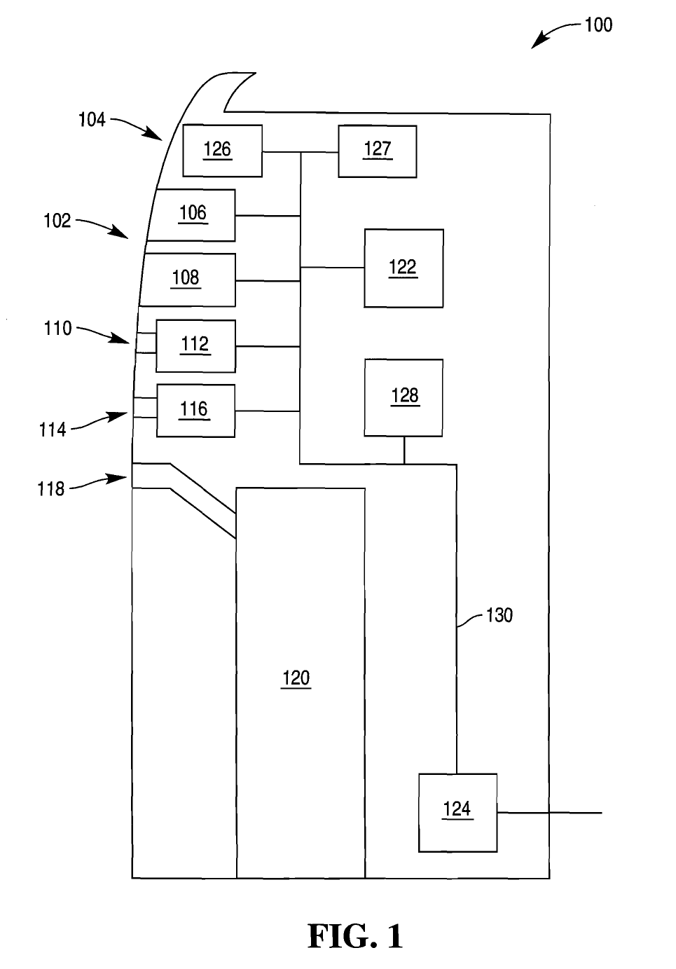

FIG. 1 illustrates a self-service terminal (SST) in the form of an ATM 100 according to one embodiment of the present invention. The ATM 100 includes a user interface 102 for input of information to, and output of information from, the ATM 100. The user interface 102 comprises a molded fascia 104 incorporating a touch screen 106 for input and output of transaction information, an encrypting keypad module 108 for input of alphanumeric, and preset function information, and a plurality of input and output slots aligned with modules located behind the fascia 104. The slots include a card entry/exit slot 110 that aligns with a magnetic card reader/writer (MCRW) module 112, a printer slot 114 that aligns with a printer module 116, and a cash dispense slot 118 that aligns with a cash dispense module 120.

In addition, the ATM 100 includes an internal journal printer module 122 for creating a record of all transactions executed by the ATM 100, and a network communication module 124 for communicating with a remote host (not shown) and the like. The ATM 100 also includes a wireless communication module, in the form of a Bluetooth (trademark) transceiver 126, for enabling information pertaining to a wireless transaction to be sent to and received from a wireless electronic device (not shown in FIG. 1) retained by a user, and a positioning system module in the form of a GPS receiver 127 for determining a position of the ATM 100. The GPS receiver 127 receives signals from one or more GPS satellites, and has an associated driver and application software implementing well known GPS protocols. In alternate embodiments, an SST in the form of an ATM 100 may be preprogrammed with information relating to its position such as where the SST is intended to be stationary, a GPS signal may be weak, and such like.

The ATM 100 also includes a controller module 128 for controlling operation of the various modules and a bus 130 for interconnecting all of the modules.

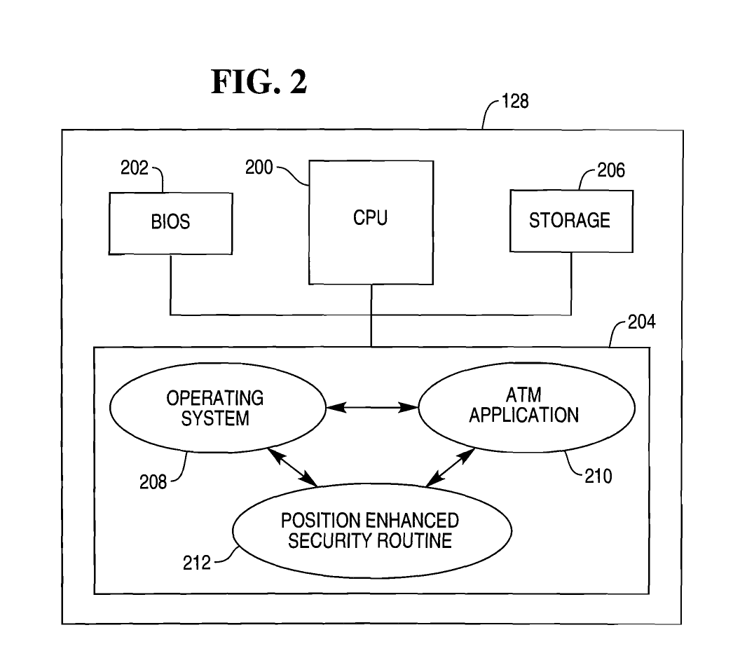

The controller module 128, shown in more detail in FIG. 2, comprises a processor 200, a basic input output system (BIOS) 202, a main memory 204 in the form of RAM, and a storage 206 in the form a magnetic disk drive. In operation the ATM 100 loads the main memory 204 with an operating system 208, an ATM application 210, and a position-enhanced security routine 212 for using position information to enhance security of a wireless transaction executed by the ATM 100.

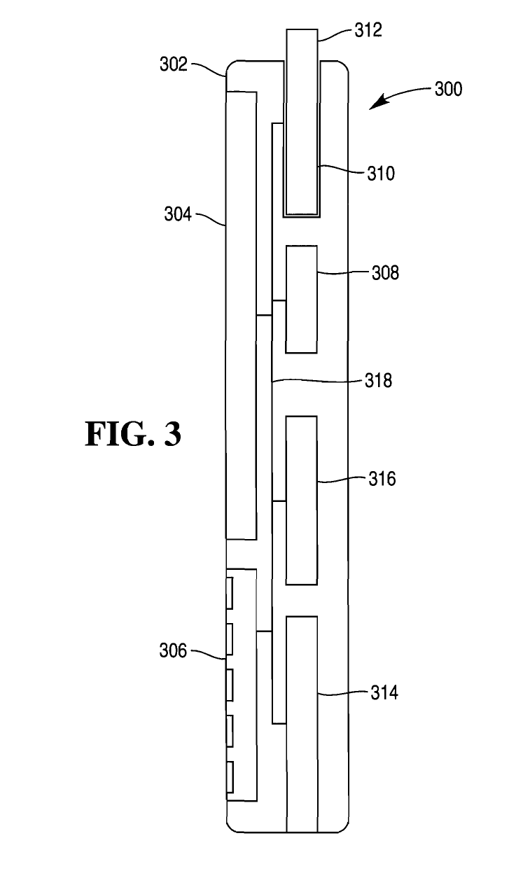

FIG. 3 shows a wireless electronic device in the form of a personal digital assistant (PDA) 300 for sending and receiving information relating to a wireless transaction to a SST such as an ATM 100. The PDA 300 includes a user interface 302 for input of information by, and output of information to, a user (not shown). The user interface 302 comprises a touch screen 304 for entry and display of transaction information, among other things, and a keypad 306 comprising one or more buttons for menu navigation, selection of preset functions, input of data and the like.

The PDA 300 also includes a communication module 308 for communicating with another wireless electronic device (not shown), and the like, and/or for enabling wireless communications with a SST such as an ATM 100. In this embodiment the communication module 308 is a Bluetooth (trademark) transceiver adapted to communicate with the Bluetooth (trademark) transceiver 126 of the ATM 100.

In addition, the PDA 300 includes an expansion card module 310 for installation of one or more expansion cards such as a positioning system card 312. In this embodiment the positioning system card 312 is a GPS receiver. The GPS receiver 312 receives signals from one or more GPS satellites, and has an associated driver and application software implementing well known GPS protocols for determining a position of the PDA 300. This typically includes determining a transmission time associated with a signal transmitted from each of the one or more satellites, determining a distance to each of the one or more satellites based on the transmission time, and determining a position based on the determined satellite distances. In alternate embodiments, the GPS receiver 312 may be fully integrated with, as opposed to being an expansion card for, the PDA 300.

In addition to the GPS receiver 312, the PDA 300 further includes a battery module 314 for providing power, a PDA controller module 316 for controlling operation of the various components of the PDA 300, and a bus 318 for interconnecting all of the various components of the PDA 300.

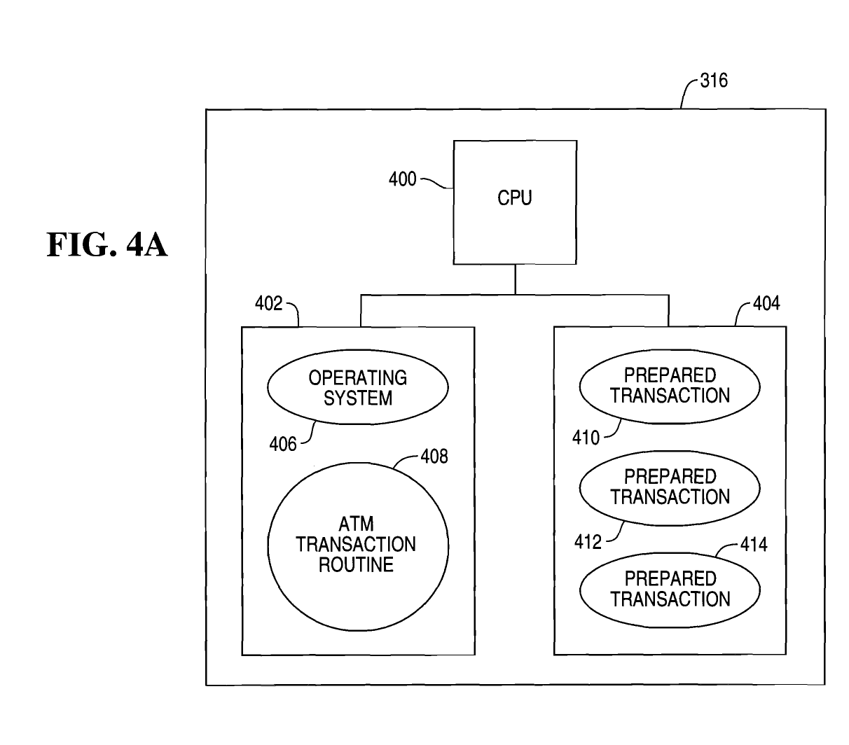

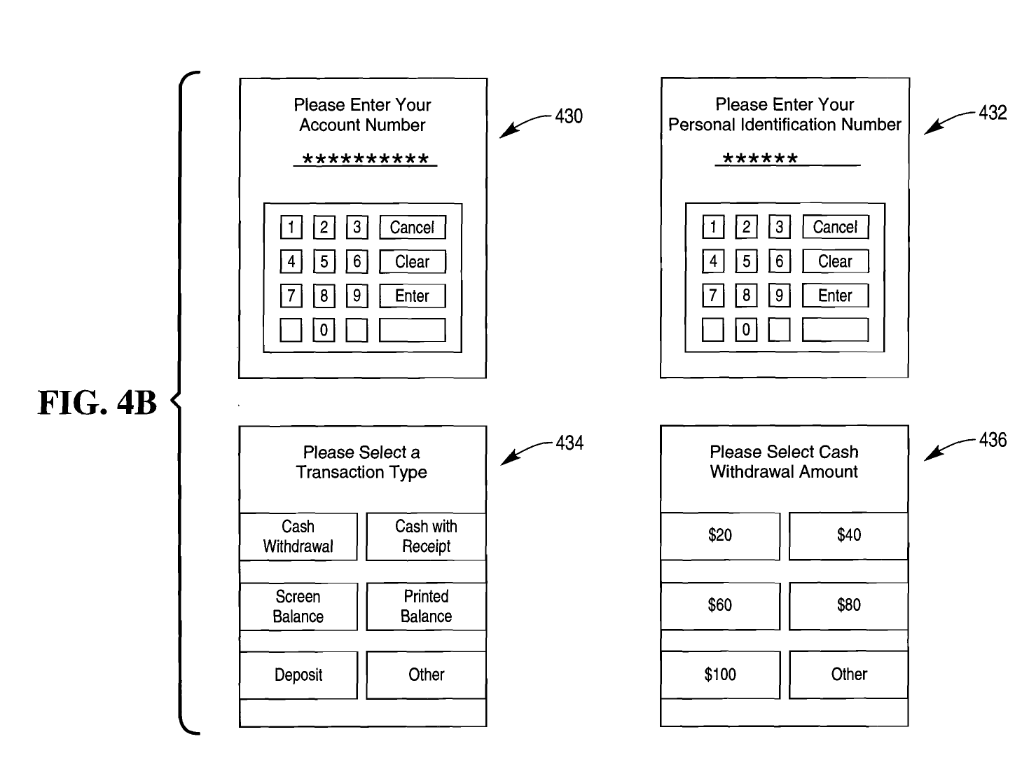

As shown in FIG. 4A, the PDA controller module 316 comprises a processor 400, volatile memory in the form of RAM 402, and non-volatile memory in the form of flash memory 404, although other types of volatile and non-volatile memory are possible. In use, a simple operating system 406 and a SST transaction routine such as an ATM transaction routine 408 are loaded into the volatile memory 402 of the PDA controller module 316.

Upon execution, the ATM transaction routine 408 provides a user of the PDA 300 with series of screens for preparing transactions for execution by an ATM 100. As illustrated in FIG. 4B, the provided screens include an account number entry screen 430, a Personal Identification Number (PIN) entry screen 432, a transaction type selection screen 434, and a cash withdrawal amount screen 436, and the like. As will be discussed further herein below, once information relating to one or more transactions or transaction steps has been entered into the PDA 300 using the ATM transaction routine 408, it may be sent to an ATM 100 for action, or stored as a prepared transaction 410, 412, 414 in the flash memory 404 of the PDA 300 for execution at a later, more convenient time.

Typically, the ATM transaction routine 408 is downloaded from a web server of a bank or other entity owning or operating the ATM 100 in advance of a user approaching the ATM 100 to perform a transaction. However, the transaction routine may also be downloaded directly from the ATM 100 on-demand, whenever the user desires to prepare a transaction for execution by the ATM 100.

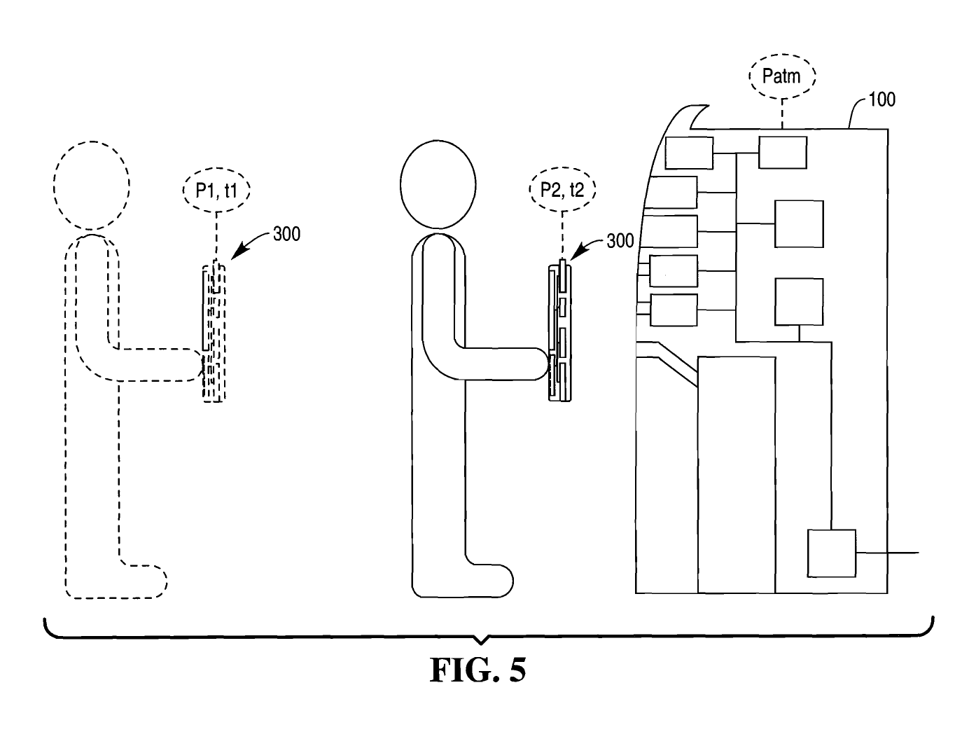

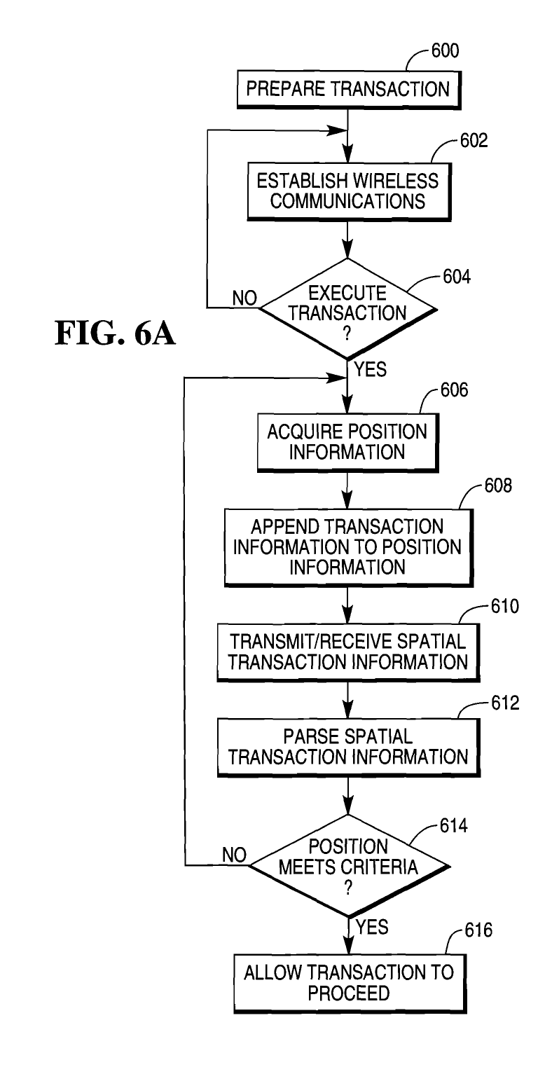

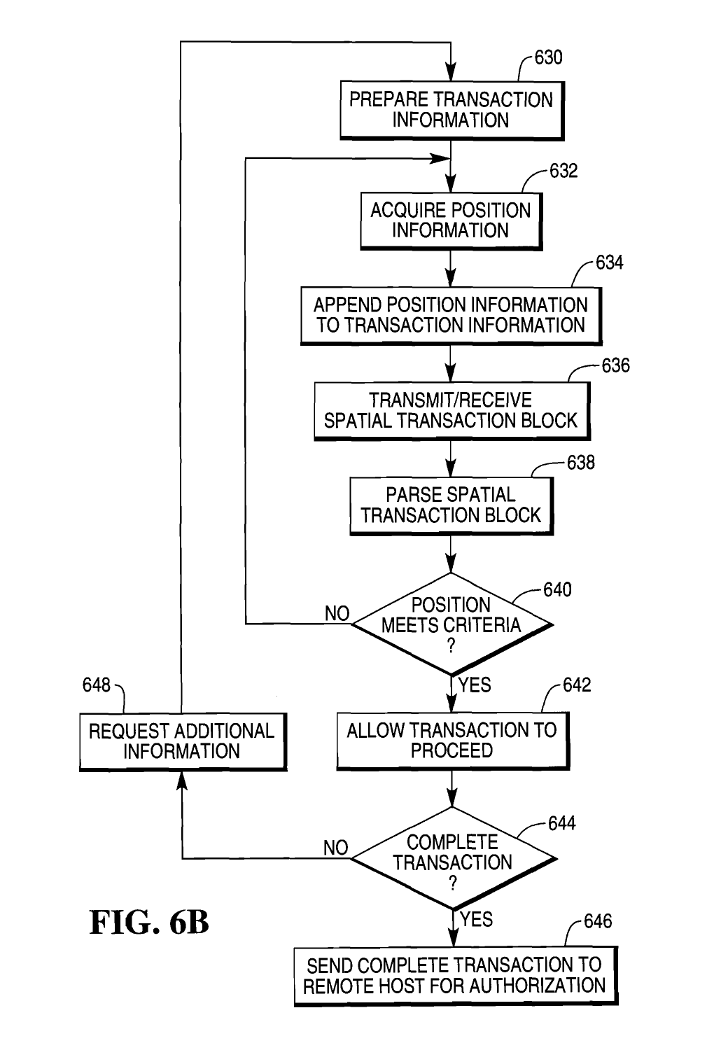

An examplar position-enhanced wireless transaction executed by an ATM 100 will now be described with reference to FIG. 5 and FIG. 6A. FIG. 5 shows a user holding a PDA 300 at a first position P1, and a second position P2, in respect to the ATM 100, where the second position P2 is closer to the ATM 100 than the first position P1. FIG. 6A shows a flow chart illustrating the steps performed by the ATM 100 and the PDA 300 to increase the security of a wireless transaction through the use of position information.

Referring to FIG. 6A, initially, in step 600, a user prepares a transaction using the ATM transaction routine 408 of the PDA 300. This comprises the user entering information pertaining to a desired transaction, such as a request to withdraw a fixed amount of cash from a savings account, pursuant to a series of screens 430, 432, 434, 436 presented by the ATM transaction routine 408 to the user on the touch screen 304 of the PDA 300, and the ATM transaction routine 408 subsequently storing the entered information as a prepared transaction 410 in the flash memory 404 of the PDA 300.

In step 602, either contemporaneous to the data entry, or at a later, more convenient time, wireless communications are established between the ATM 100 and the PDA 300. This is accomplished by the Bluetooth (trademark) transceiver 126 of the ATM 100 automatically discovering, and establishing a personal-area network (PAN) with the Bluetooth (trademark) communication module 308 of the PDA 300 using well known protocols. Upon recognition of the established PAN, the ATM transaction routine 408 prompts the user as to whether he or she desires to execute the recently prepared transaction 410, or any other previously prepared transaction 412, 414, at the ATM 100. If the user responds in the affirmative, the ATM transaction routine 408, in step 606, acquires information relating to the position of the PDA 300 from the GPS receiver 312. In this example, the acquired PDA position information comprises an absolute latitude, longitude, and altitude of the PDA 300.

In step 608, the ATM transaction routine 408 appends the acquired PDA position information to the selected, prepared transaction 410 creating a spatial transaction block. Subsequently, in step 610, the ATM transaction routine 408 wirelessly transmits the spatial transaction block to the ATM 100 using the established PAN. Then, in step 612, the position-enhanced security routine 212 of the ATM 100 parses the received spatial transaction block to identify the respective position and transaction portions.

In step 614, the position-enhanced security routine 212 determines if the received PDA position information meets one or more predetermined criteria. Each of the one or more predetermined criteria may be a simple criteria, which involves only one condition; or a complex criteria, which involves multiple conditions. As shown in step 616, if the received PDA position information meets the one or more predetermined criteria, the transaction is allowed to proceed. In this example, allowing the transaction to proceed comprises the position-enhanced security routine 212 passing required information relating to the prepared transaction 410 to the ATM application 210 for action, which includes the ATM application 210 transmitting the required transaction information to a remote host (not shown) to obtain authorization to disburse the requested amount of cash.

In the above example, the one or more predetermined criteria which the PDA position information must meet in step 614 for a given transaction to be allowed to proceed comprise the PDA 300 being within one or more known, fixed distances of the ATM 100. Such criteria can be met by, for example, the position-enhanced security routine 212 of the ATM 100 requiring that the reported, absolute position of the PDA 300 be within a range of positions surrounding the ATM 100 corresponding to the one or more fixed distances that are stored in, or otherwise accessible to the ATM 100. Likewise, this criteria can be met by the position-enhanced security routine 212 requiring that the relative position of the PDA 300 with respect to the ATM 100 be less than or equal to one or more predetermined, fixed distances that are stored in, or otherwise accessible to the ATM 100. In this embodiment, the determination of whether the position of the PDA 300 is within one or more known, fixed distances of the ATM 100 is determined through the use of differential GPS.

In differential GPS, the position of a first object is determined in reference to the position of a second, nearby object in order to reduce the influence of systematic errors, such as satellite orbit bias, on the GPS derived position information. For example, to determine the relative position of the PDA 300 with respect to the ATM 100 for use in enhancing the security of the above described wireless transaction, the position, P1, of the PDA 300 is ascertained by the ATM transaction routine 408 using the GPS receiver 312, and communicated to the ATM 100 with the related transaction information using the established PAN (steps 606-610). Subsequently, in determining if the position of the PDA 300 meets the one or more predetermined criteria (step 614), namely that the position of the PDA 300 be within one or more known, fixed distances of the ATM 100, the position-enhanced security routine 212 first determines the position, Patm, of the ATM 100 using a GPS receiver 127 associated with the ATM 100. Then, the position-enhanced security routine 212 calculates the difference in position of the PDA 300 with respect to the ATM 100 using the respective PDA 300 and ATM 100 GPS position information, and compares this difference with the known, fixed distances retrieved from the local storage 206 of the ATM 100. If the difference in position of the PDA 300 and the ATM 100 as determined using their respective GPS information is within the known, fixed distances, the transaction is, in step 616, allowed to proceed. In this way, the influence of any systematic errors associated with the use of the GPS receiver 312 of the PDA 300, as well as the GPS receiver associated with the ATM 100, is reduced, and the resultant accuracy of determining the relative position of the PDA 300 with respect to the ATM 100 is increased.

Likewise, where an absolute position of the PDA 300 is used to enhance the security of the above described wireless transaction, the position, P1, of the PDA 300 is also determined by the ATM transaction routine 408 using the GPS receiver 312, and communicated to the ATM 100 with related transaction information using the established PAN (steps 606-610). Similarly, in determining if the position of the PDA 300 meets the one or more predetermined criteria (step 614), namely that the PDA 300 be within one or more known, fixed distances of the ATM 100, the position-enhanced security routine 212 first determines the position, Patm, of the ATM 100 using the GPS receiver 127 associated with the ATM 100. Advantageously, the ATM 100 also stores, or otherwise has access to, information pertaining to its actual position, absent any of the bias which may exist in the GPS derived position. In this example, the actual position of the ATM 100 is stored in, and retrieved from a local storage 206 of the ATM 100 (this may even be used instead of having a GPS received installed in the ATM). After retrieval, the position-enhanced security routine 212 determines the difference between the retrieved, actual position of the ATM 100 and the GPS indicated position. Subsequently, this difference is applied as a correction to the PDA position information received by the position-enhanced security routine 212 from the PDA 300, to provide a corrected, absolute position of the PDA 300. The corrected position of the PDA 300 is then compared by the position-enhanced security routine 212 to a range of positions corresponding to the known, fixed distances from the ATM 100. In this example, the allowable range of positions comprises a range of latitudes, longitudes and altitudes retrieved from the local storage 206 of the ATM 100. If the corrected position of the PDA 300 is found to be within the allowable range of latitudes, longitudes and altitudes, the transaction is, in step 616, allowed to proceed. If not, PDA position information is, in step 606, reacquired, and the process starts anew. In this way, the accuracy of determining the absolute position of the PDA 300 is improved, and errors associated with its use are reduced.

In addition to improving security for execution of a prepared transaction 410, it is also possible to improve security of a transaction that is entered and/or executed interactively with an ATM 100. In such case, transaction information comprising one or more steps intermediate to a complete transaction may be entered in a PDA 300 using an ATM transaction routine 408, appended to PDA position information obtained using a GPS receiver 312, and transmitted to a SST such as an ATM 100 for action. An example interactive transaction employing position-enhanced wireless security is illustrated in FIG. 6B.

Referring to FIG. 6B, at step 630 first transaction step information comprising, for example, user and/or account information, is entered via a screen 430 provided by the ATM transaction routine 408 running on the PDA 300. Then, at step 632, first position information, P1, corresponding to the current position of the PDA 300 is obtained by the ATM transaction routine 408 using the GPS receiver 312 of the PDA 300. Subsequently, in step 634, the obtained first position information is appended to the entered first transaction step information creating a first spatial transaction block. In step 636 the first spatial transaction block is then transmitted to the ATM 100 using a previously or contemporaneously established PAN.

In step 638, the position-enhanced security routine 212 of the ATM 100 parses the received first spatial transaction block to identify the respective position and transaction information portions. Subsequently, in step 640, the position-enhanced security routine 212 verifies that the position information meets one or more predetermined criteria. If the position information meets the one or more predetermined criteria, the position-enhanced security routine 212, in step 642, allows the transaction to proceed, which in this example entails the position-enhanced security routine 212 determining if the ATM 100 has received information comprising a complete transaction in step 644. If it is determined that the ATM 100 has received information comprising a complete transaction, the position-enhanced security routine 212 in step 646 passes required information relating to the complete transaction to the ATM application 210 for action, which in this example includes the ATM application 210 transmitting the required information to a remote host (not shown) to obtain authorization to fulfill the transaction.

If, however, the position-enhanced security routine 212 determines in step 644 that the ATM 100 has not received information comprising a complete transaction, or if further input and/or authorization is needed from the user prior to attempting to fulfill the transaction, the ATM 100, in step 648, may transmit a signal to the PDA 300 requesting further information using the established PAN. This may include the ATM 100 transmitting a signal to the PDA 300 instructing the ATM transaction routine 408 to provide an additional screen to the user, such as a screen requesting input of a PIN 432, selection of a desired transaction type 434, or selection of a cash withdrawal amount 436, and the like. Upon provision of the screen, the user may then enter the requested information and/or select among the provided options, and thereby prepare second transaction step information (step 630). Such second transaction step information is, then, appended to second position information, P2, of the PDA 300, obtained by the ATM transaction routine 408 using the GPS receiver 312 of the PDA 300 (steps 632 and 634), and transmitted to the ATM 100 as a second spatial transaction block (step 636).

The position-enhanced security routine 212 of the ATM 100 then parses the received second spatial transaction block to identify the respective position and transaction portions (step 638), and determine if the contained second position information meets one or more predetermined criteria (step 640). If the second position information meets the one or more predetermined criteria, the transaction is allowed to proceed (step 642), which in this example entails the position-enhanced security routine 212 again determining if information comprising a complete transaction has been received by the ATM 100 (step 644).

As indicated in FIG. 6B, this process is repeated until information comprising a complete transaction, including any required user authorization and/or acknowledgement, is received by the ATM 100, and the associated position information is validated, at which point required information concerning the complete transaction is forwarded to the ATM application 210, and ultimately to a remote host (not shown) for authorization to fulfill the transaction (step 646). In this way multi-step transactions, or multiple complete transactions, can be piecewise transmitted from a wireless electronic device such as a PDA 300, for acting upon by a SST such as an ATM 100 while using position information to enhance the security of each data transmission.

In addition to requesting additional information from a user, as described above in reference to step 648 of FIG. 6B, the position-enhanced security routine 212 of an ATM 100 may also provide information, such as information regarding the status of a transaction, to a user of a PDA 300. Transaction status information may, for example, comprise an indication that authorization for the transaction has been requested, and is pending, from a remote server, or that a cash dispense module 120 of the ATM 100 is preparing to dispense cash through a cash dispense slot 118, and the like. Such transaction status information may further include a request for information upon acknowledgement and/or approval of the status information by the user.

For example, a user desiring to execute a cash withdrawal transaction at a SST in the form of an ATM 100 using a PDA 300, approaches the ATM 100 and establishes a PAN between the PDA 300 and the ATM 100 using well known Bluetooth (trademark) protocols. The user can then enter required transaction information into the PDA 300 using the ATM transaction routine 408, or choose to execute one or more prepared transactions 410, 412, 414 stored in, for example, the flash memory 404 of the PDA 300. In alternate embodiments, the one or more prepared transactions 410, 412, 414 may be stored in volatile memory such as RAM 402, or other, non-volatile memory such as a hard disk (not shown). Upon input of required transaction information and/or selection of a prepared transaction 410, 412, 414 for execution, the ATM transaction routine 408 of the PDA 300 obtains information relating to the position of the PDA 300 from the GPS receiver 312, and appends this information to the transaction information creating a spatial transaction block. The ATM transaction routine 408 then wirelessly transmits the spatial transaction block to the ATM 100 using the established PAN.

Upon receipt, the position-enhanced security routine 212 of the ATM 100 parses the spatial transaction block to identify the respective position and transaction portions. After validating that the position information meets one or more predetermined criteria, the ATM 100 transmits required transaction information to a remote host (not shown) for authorization of the transaction in exactly the same way as for a transaction entered directly at the ATM 100. If the transaction is authorized by the remote host, then the position-enhanced security routine 212 transmits a message to the PDA 300 using the established PAN indicating that the requested amount of cash is ready to be dispensed, and requesting input from the user that he or she is in position to receive it.

The user then enters an appropriate response in the PDA 300, which response is further appended to current position information and transmitted to the ATM 100. Upon receipt, and validation of the response and associated position information, the ATM 100 will fulfill the requested cash withdrawal transaction by activating the cash dispense module 120 to dispense the requested amount of cash via the cash dispense slot 118. However, if no, or no valid response is received within a predetermined period of time, the requested transaction may be aborted by the ATM 100.

In the interactive transaction example described above with respect to FIG. 6B, security may further be enhanced by appending ATM position information, Patm, to the signal requesting information from, and/or providing information to, a user prior to transmission of that signal to the PDA 300. Upon receipt, the PDA 300 may then parse the resulting ATM spatial transaction block, and use the respective position portion to verify that it is communicating with an expected ATM 100 prior to acting on the signal portion.

In such case, position information, Patm, of the ATM 100 may be ascertained by the ATM 100 through use of a GPS receiver 127 included with the ATM 100. Alternately, the ATM position information, Patm, may be retrieved on-demand from a storage 206 of the ATM 100, or from a remote server (not shown) accessible to the ATM 100 through use of the communication module 124, and the like.

It will now be appreciated that enhanced security can be provided for wireless transactions using position information.

Some alternative and/or additional embodiments will now be described.

For example, while the above embodiments relate primarily to an ATM 100, they are equally applicable to any of a number of SSTs including self-checkout units, self-service kiosks, point-of-service (POS) workstations, other kiosks, and the like.

In accordance with one such embodiment, the present invention may also be used with any apparatus providing secured access such as a parking garage that requires use of an authorization code to enter and/or exit the garage. In one such example, a user paying a cashier to park in the garage for a specified term is provided with an authorization code indicative of the payment amount and associated term. The provided authorization code is, then, entered into a PDA 300 in the possession of the user, either manually, or automatically through use of a Bluetooth (trademark) transceiver 308 of the PDA 300. Subsequently, when the user approaches the parking garage entrance or exit in his or her vehicle, the PDA 300 in the possession of the user establishes wireless communications with a SST in the form of a wireless tollbooth, and transmits the authorization code for parking at the garage along with information indicative of the position of the PDA 300. After receipt, the wireless tollbooth determines that the provided code is proper, and that the provided position information meets one or more predetermined criteria in advance of allowing the vehicle to enter and/or exit from the garage. The wireless tollbooth may control entry/exit through the use of an associated entry/exit gate. The one or more predetermined criteria may comprise the PDA 300 being within a known, fixed distance of the wireless tollbooth. However, it may also comprise the change in position of the PDA 300 being less than or equal to one or more predetermined values, being directionally toward, as opposed to away from the gate, or being in a correct direction with respect to entry/exit through the gate, and the like, to ensure that the gate is not erroneously opened and/or closed.

Similarly, while one of the above embodiments has been described primarily with reference to a cash withdrawal transaction at an ATM 100, the security of any one of a number of wireless transactions available through the use of any SST, including an ATM 100, may be enhanced using position information. These include requests for a SST to transfer funds among available accounts, charge an account for goods or services, dispense and/or refill valuable media such as one or more of a debit card, a pre-payment card, a loyalty card, a purchasing card, a store card, a gift card, a travel and entertainment card, a check, a receipt, a ticket, a voucher, a coupon, a token, a postage stamp, and the like. Similarly, wireless requests to purchase one or more pre-printed and/or pre-manufactured items such as snacks, cigarettes, toiletries, beverages, cellular telephones, and the like may be secured using position information.

Likewise, in addition to the previously discussed latitude, longitude, and altitude information, the requisite position information may comprise satellite signal transmissions times, satellite signal delays, satellite distances, and/or any other information available through use of a GPS receiver or any other positioning system device. Further, the position information may be provided in any available unit set (e.g., feet, meters, degrees, minutes, seconds, etc.), and/or in non-dimensional form.

Further, in some embodiments, the requisite position information may be sent separately from, as opposed to being appended to, transaction information. In this way the position information may be used to, for example, validate the position of a wireless electronic device such as a PDA 300 in advance of receiving and/or acting on the separately transmitted transaction information.

In addition, in some embodiments, position information such as latitude, longitude and/or altitude data obtained through use of a positioning system may be hashed with transmitted transaction data, one or both of which may further be encrypted according to a public key/private key encryption scheme to further secure the transmitted data, and decrease the likelihood of a man-in-the-middle attack. Various other security means including, but not limited to, additional encryption and/or digital certificate technologies can be used in concert with the disclosed position-enhanced wireless security technology as part of an overall transaction data security system. The position information itself may be used as a key to encrypt transmitted information so that only information transmitted from within a predetermined area of the SST will be successfully decrypted by the SST.

In addition to comprising one or more fixed values against which received position information is compared, the one or more predetermined criteria may require that the received position information be within some predetermined tolerance of one or more fixed values, in order for a given transaction or step thereof to be allowed to proceed. For example, the predetermined criteria which the position of a wireless electronic device such as a PDA 300 must meet may require that longitude information received from the PDA 300 be within a first predetermined tolerance of a known longitude, and that received latitude information be within a second predetermined tolerance of a known latitude.

Likewise, whether a single value or a range of values with associated tolerances, the one or more predetermined criteria which the position information must meet for a given transaction or step thereof to be allowed to proceed may vary depending on the type or step of the transaction requested. For example, in reference to FIG. 3 and FIG. 5, a balance inquiry transaction, wherein the balance information is provided to a user via a touch screen 304 of a PDA 300, may be allowed to proceed when the position information obtained through use of a GPS receiver 312 indicates that the PDA 300 is at a first position, P1, relatively far from an ATM 100. However, a cash withdrawal transaction may only be allowed to proceed when the position information indicates that the PDA 300 is at a second position, P2, relatively close to the ATM 100 to ensure that any resultant cash disbursement is made to an authorized user. In any case, differential GPS may be used to improve the accuracy of, and reduce systematic error associated with, any utilized position information. This enables transactions involving physical fulfillment (for example, receipt printing, statement printing, cash dispensing, and such like) to be executed only when the user is in close proximity to the SST; whereas, transactions not involving any physical disbursement (for example, transfer of funds, balance inquiry, and such like) may be executed regardless of the physical location of the user, or if the user is within a relatively wide range of the SST.

Where more than one criteria are used, such as where the criteria vary with the transaction type or step, the utilized, plural predetermined criteria may be made available to the ATM 100 and/or the PDA 300 in the form of a look-up table. For example, a look-up table comprising a range of allowable relative or absolute positions for the position information of the PDA 300 to be within may be provided in a storage 206 of the ATM 100, any one of which if met will result in the ATM 100 taking action regarding the respective transaction or transaction step. In another example, a look-up table comprising a plurality of transaction types or steps, each of which is associated with one or more predetermined criteria, may be provided in a local storage 206 of the ATM 100. In this case, the one or more predetermined criteria associated with the specific, transaction type or step must be met for action to be taken in regard to that transaction type or step. Where provided, some or all of the look-up table may alternately or additionally be stored on a remote server (not shown), and retrieved on-demand by the ATM 100 through use of an appropriate communication module 124, 126.

While the one or more predetermined criteria is ordinarily be provided in a local storage 206 of, or a remote storage (not shown) accessible to, a SST such as an ATM 100, some or all of the predetermined criteria required to be met by the ATM 100 for a requested transaction to be allowed to proceed may also be provided by a user of a wireless electronic device such as a PDA 300. In such case, the user-provided criteria may be transmitted to the ATM 100 separately from, or along with requisite position and/or requested transaction information. In one example, the ATM 100 may not allow some or all of the steps of a requested transaction to proceed until the user-provided criteria is separately or additionally met. In a further example, the user-provided criteria may be implemented only if it is more stringent than any related criteria provide in the local 206 or remote storage accessible to the ATM 100. The inclusion of one or more user-provided criteria allows different users possessing different physical characteristics and/or desiring different security levels to tailor the criteria used in determining whether to allow some or all of the steps of a requested transaction to proceed to meet their individual needs.

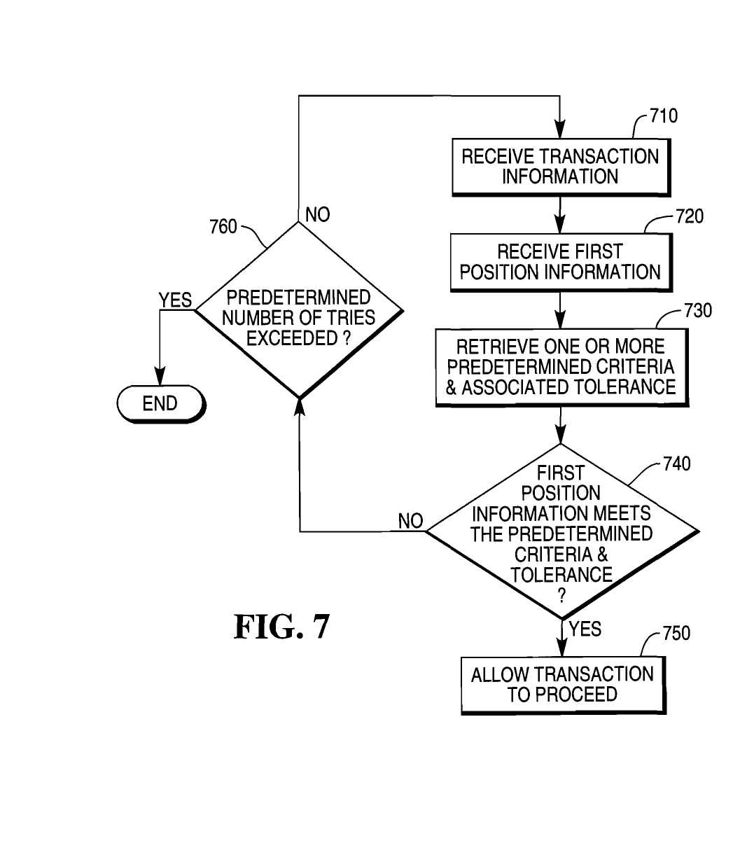

Additionally, rather than singly, or infinitely, determining if provided position information meets one or more predetermined criteria, a SST such as an ATM 100 may allow a finite number of repeat attempts for the proper position information to be provided prior to declining to take action on one or more steps of a given transaction. For example, as illustrated in FIG. 7, after failing to meet the one or more predetermined criteria (step 740), an SST in the form of an ATM 100 may determine if a predetermined number of tries for meeting the predetermined criteria have been exceeded (step 760). If the predetermined number of tries has not been exceeded, the transaction and position information may again be sent by a wireless electronic device such as a PDA 300 to the ATM 100 pursuant to an established communication link (step 710, 720), and compared against one or more retrieved criteria (step 730, 740). Alternately, where the ATM 100 has already received related or required transaction information, only the position information may be required to be resent to the ATM 100 by the PDA 300. Regardless, where the predetermined number of tries is determined to have been exceeded (step 760), the process ends and further attempts to act on a requested transaction or transaction step may be prohibited, and/or additional levels of security may be required, prior to allowing some or all of the requested transaction to proceed.

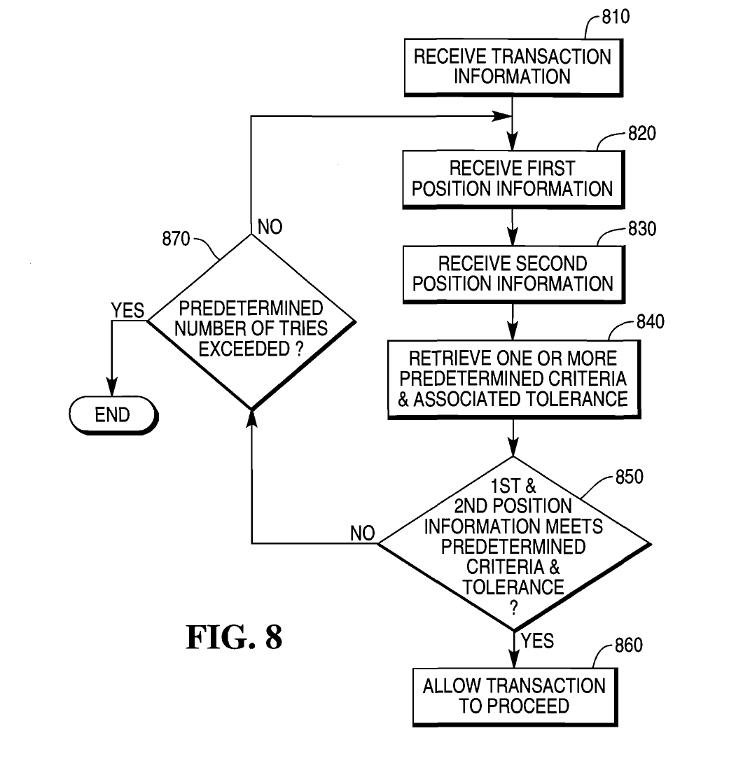

Further, in some applications, limitations may be placed on a change in relative or absolute position of a wireless electronic device such as a PDA 300 for a requested transaction at a SST such as an ATM 100 to be allowed. In one example, illustrated in FIG. 8, the ATM 100 receives information indicative of a first position, P1, of the PDA 300 (step 820). Subsequently, the ATM 100 receives information indicative of a second position, P2, of the PDA 300 (step 830). The second position information may be received separately from, or accompanied by the first position information, either or both of which may further be appended to the transaction information. Then, the ATM 100 determines if the received first and second position information meets one or more retrieved predetermined criteria (step 840), such as the change in absolute position, P1-P2, of the PDA 300 being ten meters, plus or minus a tolerance of two meters (step 850). If the received first and second position information meets the one or more predetermined criteria, the transaction is allowed to proceed (step 860). If not, the process is repeated for a predetermined number of tries (step 870), or until it is successful, whichever comes first.

In addition to the above, the ATM 100 may further require that either or both of the first and second positions of the PDA 300, P1 and P2, meet a second, predetermined criteria, such as each being within two meters of the ATM 100, or the change in position of the wireless electronic device, P2-P1, be directionally toward, as opposed to away from the ATM 100, and the like, for action on the transaction or transaction step be allowed to proceed.

As a means to further enhance security, first and/or second position information, P1 and P2, of a PDA 300 may also be associated with information relating to times, t1 and t2, at which the first and second position information, P1 and P2, respectively, were determined. Such time information may be received from the PDA 300 with the first and second position information, or may be determined from the times of receipt of the various pieces of information by the ATM 100, among other means. Associated time information may be used in conjunction with the first, second, and/or ATM position information, P1, P2 and Patm, respectively, to determine one or more rates of change of position of the PDA 300 with respect to time on a relative basis and/or with respect to the ATM 100, and the like. The predetermined criteria may, for example, comprise allowing the transaction to proceed where the one or more determined rates of change in position are less than or equal to one or more predetermined values.

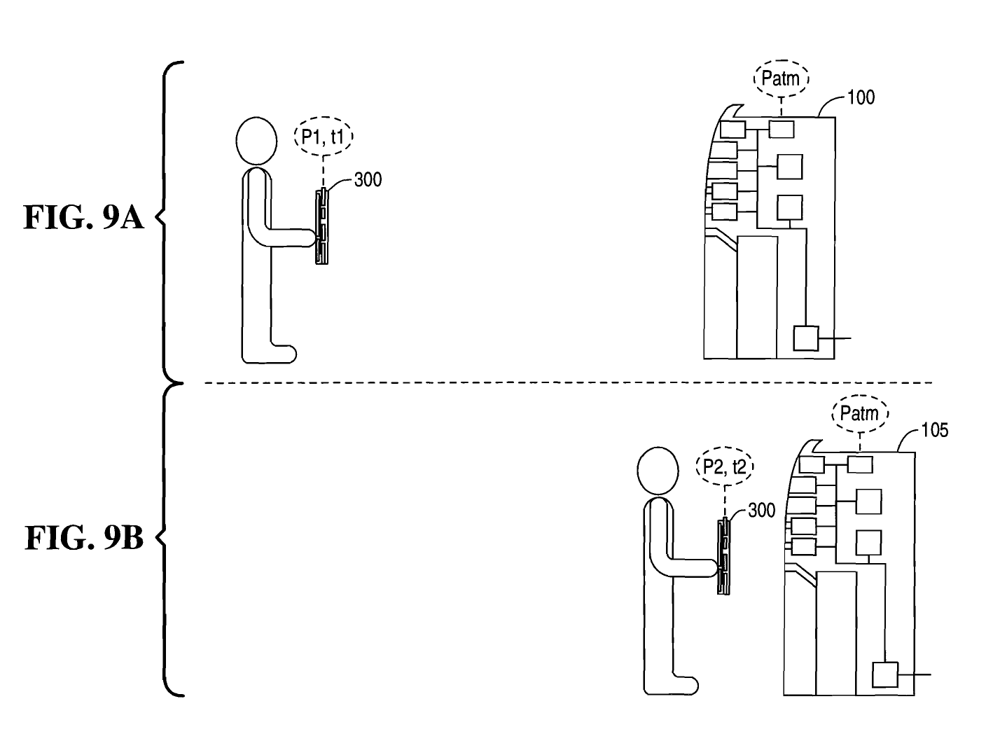

Although the above embodiments have largely been discussed with regard to executing a wireless transaction with a single SST, it is also possible to initiate a transaction at a first SST and fulfill the transaction at a second, different SST with position-enhanced wireless transaction security. For example, as illustrated in FIG. 9A, action regarding a first transaction step transmitted from a PDA 300 to a first SST in the form of a first ATM 100 may be allowed to proceed if the PDA 300 is within a first predetermined distance (e.g., P1-Patm) of the first ATM 100. However, as illustrated in FIG. 9B, action regarding a second transaction step transmitted to a second ATM 105, such as the dispensing of cash or other valuable media, may only be allowed to proceed by the second ATM 105 if the PDA 300 is within a second predetermined distance (e.g., P2-Patm) from the second ATM 105. Such an application allows a user to take advantage of a network of SSTs such as the first and second ATMs 100, 105, to conveniently initiate a transaction with any one of a number of available SSTs in the network, while limiting fulfillment of the transaction, such as through the disbursement of valuable media, to occur only at a SST proximate to the user. In such case, transaction information communicated to the first SST, such as the first ATM 100 may be stored in a local storage 206 of the first ATM 100, or in a remote storage (not shown), accessible to the second ATM 105 through use of an appropriate communication module 124, 126 associated with the respective ATMs.

While the subject invention has been disclosed with respect to a limited number of embodiments, those skilled in the art will appreciate numerous modifications and variations exist therefrom. It is intended that the appended claims cover such modifications and variations as fall within the true spirit and scope of the invention.

What is claimed is:

1. A method of operating a self-service terminal to secure a wireless transaction using position information, the method comprising:
wirelessly receiving information relating to a transaction from a wireless electronic device;
wirelessly receiving information indicative of a first position of the wireless electronic device;
determining if the first position information meets one or more predetermined criteria; and
taking action on the transaction information in the event that the first position information meets the one or more predetermined criteria.

2. The method of claim 1, wherein taking action on the transaction information includes dispensing at least one physical item to fulfill the transaction.

3. The method of claim 1, further comprising retrieving information indicative of a position of the self-service terminal.

4. The method of claim 3, wherein determining if the first position information meets one or more predetermined criteria includes comparing the first position information with the information indicative of the position of the self-service terminal to ascertain if the wireless electronic device is within a predetermined distance of the self-service terminal.

5. The method of claim 1, wherein the transaction information and the first position information are received as part of a spatial transaction block.

6. The method of claim 5, further comprising parsing the spatial transaction block to identify the respective transaction and first position information portions.

7. The method of claim 1, wherein the first position information is obtained through use of a satellite navigation system associated with the wireless electronic device.

8. The method of claim 7, wherein the satellite navigation system comprises GPS.

9. The method of claim 1, further comprising:
wirelessly receiving information indicative of a second position of the wireless electronic device;
determining if the second position information meets the one or more predetermined criteria; and
taking action on the transaction information in the event that the first and second position information meet the one or more predetermined criteria.

10. The method of claim 9, wherein at least one of the one or more predetermined criteria comprises a difference between a first and a second position of the wireless electronic device as determined through use of the first and second position information being less than or equal to a predetermined value.

11. The method of claim 9, further comprising:
wirelessly receiving a first time associated with the first position information;
wirelessly receiving a second time associated with the second position information;
determining if the first and second times meet the one or more predetermined criteria; and
taking action on the transaction information in the event that the first and second position information and the first and second times meet the one or more predetermined criteria.

12. The method of claim 11, further comprising:
calculating a rate of change of position of the wireless electronic device using the first and second position information and the first and second times, and
wherein at least one of the one or more predetermined criteria comprises the rate of change of position of the wireless electronic device being less than or equal to a predetermined value.

13. The method of claim 1, further comprising:
determining a type of transaction represented by the transaction information; and
varying at least one of the one or more predetermined criteria as a function of the determined transaction type.

14. The method of claim 1, further comprising wirelessly receiving at least one of the one or more predetermined criteria from the wireless electronic device.

15. A method of using a wireless electronic device as a secure interface for execution of a wireless transaction by a self-service terminal, the method comprising:
receiving into the wireless electronic device information relating to a transaction;
acquiring information indicative of a first position of the wireless electronic device;
appending the first position information to the transaction information to create a spatial transaction block; and
wirelessly transmitting the spatial transaction block to the self-service terminal.

16. The method of claim 15, further comprising:
establishing a wireless communication link between the wireless electronic device and the self-service terminal; and
wirelessly transmitting the spatial transaction block to the self-service terminal using the established wireless communication link.

17. A self-service terminal comprising:
a communication module adapted to wirelessly receive information relating to a transaction from a wireless electronic device, and to wirelessly receive information indicative of a first position of the wireless electronic device from the wireless electronic device; and
a controller adapted to determine if the first position information meets one or more predetermined criteria, and take action on the received transaction information in the event that the first position information meets the one or more predetermined criteria.

18. The self-service terminal of claim 17, wherein the communication module is further adapted to wirelessly receive information indicative of a second position of the wireless electronic device, and the controller is further adapted to determine if the second position information meets the one or more predetermined criteria and take action on the transaction information in the event that the first and second position information meet the one or more predetermined criteria.

19. The self-service terminal of claim 18, further comprising:
a clock adapted to determine a first time to be associated with the first position information and a second time to be associated with the second position information, and
wherein the controller is further adapted to take action on the transaction information in the event that the first and second position information and the first and second times meet the one or more predetermined criteria.

20. The self-service terminal of claim 17, further comprising:
a positioning system module adapted to provide information indicative of a position of the self-service terminal, and
wherein the controller is further adapted to take action on the transaction information in the event that the first position information and the provided self-service terminal position information meet the one or more predetermined criteria.

21. The self-service terminal of claim 20, wherein the positioning system module comprises a GPS module.

22. A wireless electronic device comprising:
a data entry module adapted to allow entry of information relating to a transaction for execution by a self-service terminal;
a positioning system module adapted to acquire information indicative of a first position of the wireless electronic device; and
a communication module adapted to establish a wireless communication link with the self-service terminal, and wirelessly transmit the transaction information and the first position information to the self-service terminal using the established wireless communication link.

23. The wireless electronic device of claim 22, further comprising:
a controller adapted to append the first position information to the transaction information to create a spatial transaction block,
wherein the communication module is further adapted to establish a wireless communication link with the self-service terminal, and wirelessly transmit the spatial transaction block to the self-service terminal using the established wireless communication link

24. The wireless electronic device of claim 22, wherein the positioning system module is further adapted to acquire information indicative of a second position of the wireless electronic device, and the communication module is further adapted to wirelessly transmit the second position information to the self-service terminal using the established communication link.

25. The wireless electronic device of claim 22, wherein the positioning system module comprises a GPS module.
